(19) United States
(12) Patent Application Publication
(10) Pub. No.: US 2024/0109390 A1
(43) Pub. Date: Apr. 4, 2024

(54) DAMPER ASSEMBLY INCLUDING INTAKE VALVE IN FLUID CHAMBER

(71) Applicant: DRiV Automotive Inc., Skokie, IL (US)

(72) Inventors: Stefan Deferme, Poort Sint-Truiden (BE); Bert Louis Jozef Diels, Geel (BE); Gert Mangelschots, Heusden-Zolder (BE)

(73) Assignee: DRiV Automotive Inc., Skokie, IL (US)

(21) Appl. No.: 17/936,700

(22) Filed: Sep. 29, 2022

(51) Int. Cl. B60G 17/08; B60G 13/06; B60G 15/06

(52) U.S. Cl. CPC B60G 17/08; B60G 13/06; B60G 15/062; B60G 2202/24; B60G 2204/4402; B60G 2206/41

(57) ABSTRACT

A damper includes an inner tube elongated along an axis, a piston slidably disposed in the inner tube, and an outer tube surrounding the inner tube. The inner tube and outer tube define a fluid chamber therebetween. The damper includes and intake assembly in the fluid chamber. The intake assembly includes a unitary support ring and pair of fulcrum spacers, a support post fixed to and extending along the axis away from the unitary support ring and pair of fulcrum spacers, and a valve ring supported by the support post. The valve ring defines an orifice. A valve disc is supported by the support post between the valve ring and the unitary support ring and pair of fulcrum spacers. The valve disc covers the orifice of the valve ring.

### FIELD

The present disclosure generally relates to dampers. More particularly, the present disclosure relates to a damper with external active control valves and a passive intake valve that selectively allows flow between a rebound working chamber and a compression working chamber.

### BACKGROUND

Dampers for vehicles are commonly included in a wide variety of vehicle segments. Some vehicles include semi-active damping that adjusts damping levels according to road conditions and vehicle dynamics. The dampers are between a body and the suspension system of the vehicle. A piston is located within the damper. The piston is connected to the vehicle body or the suspension of the vehicle through a piston rod. As the damper is compressed or extended, fluid flows between rebound and compression working chambers within the damper to counteract vibrations. By adjusting the flow of damping fluid between the chambers, greater or lower damping forces may be generated.

### BRIEF DESCRIPTION OF THE DRAWINGS

FIG. 1 is a schematic illustration of a vehicle including a suspension system having a plurality of damper assemblies.

FIG. 2 is a cross-sectional view of a damper assembly in a rebound stroke.

FIG. 3 is a cross-sectional view of the damper assembly in a compression stroke.

FIG. 4 is an exploded view of components of the damper assembly including an intake valve.

FIG. 5 is a cross-sectional view of components of the damper assembly including the intake valve.

FIG. 6 is an illustration of flow chart with step to assembly the intake assembly.

FIG. 7 is a cross-sectional of components of the intake assembly before assembly.

FIG. 8 is a cross-sectional the intake assembly after assembly.

FIG. 9 is a perspective view of the assembly installed on an inner tube of the damper.

### DETAILED DESCRIPTION

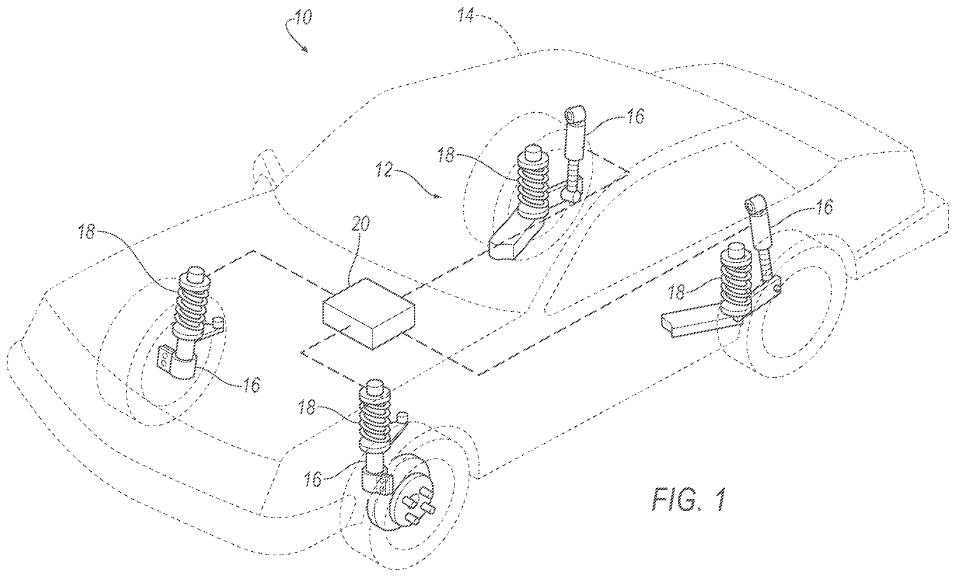

The present disclosure relates to a damping system that may continuously adjust damping levels according to road conditions and vehicle 10 dynamics. With reference to FIG. 1 there is shown a vehicle 10 having a suspension system 12 and a body 14. The suspension system 12 includes dampers 16 and coil springs 18. The dampers 16 may be semi-active with damping levels controlled by an Electronic Control Unit (ECU 20). ECU 20 receives information (acceleration, displacement, steering, breaking, speed) from sensors (not shown) at various locations on the vehicle 10 to make independent adjustments to each damper 16.

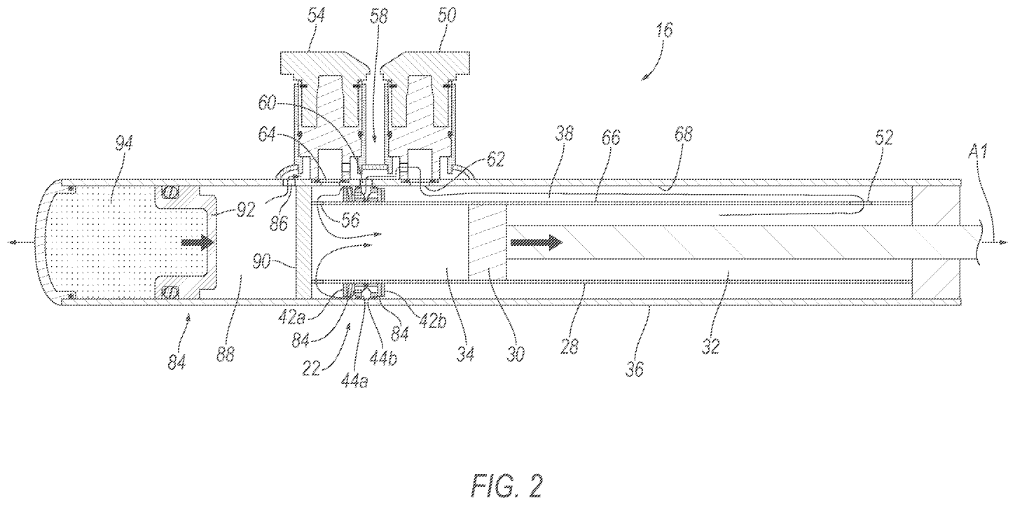

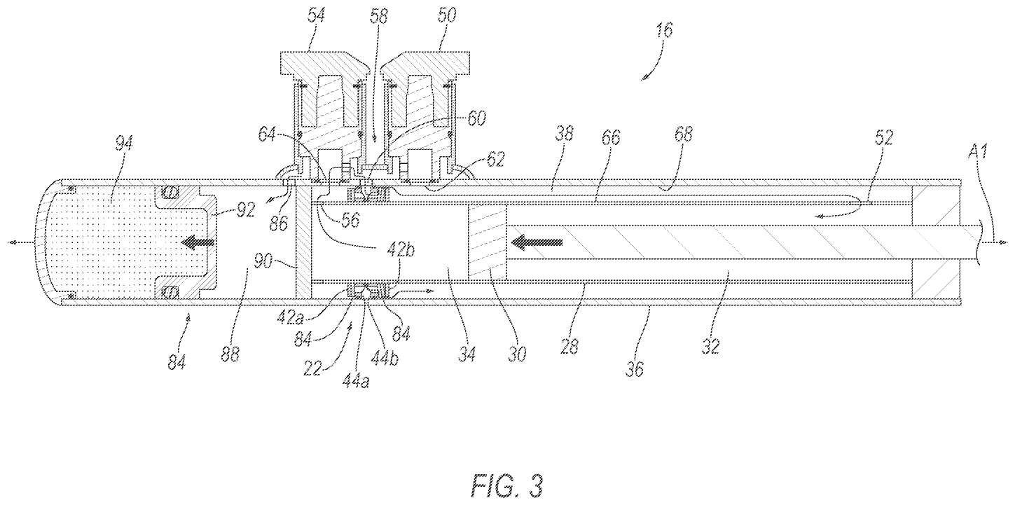

With reference to FIGS. 2 and 3 the exemplary disclosure provides a damper 16 that includes an intake assembly 22 with at least one unitary support ring 24a, 24b and pair of fulcrum spacers 26a, 26b. Unitary means a single, uniform piece of material with no seams, joints, fasteners, or adhesives holding it together, i.e., formed together simultaneously as a single continuous unit, e.g., by machining from a unitary blank, molding, forging, casting, etc. The unitary support ring 24a, 24b and pair of fulcrum spacers 26a, 26b enable increased assembly efficiencies, e.g., relative to conventional structures and methods.

The dampers 16 include an inner tube 28 elongated along an axis A1, and a piston 30 slidably disposed in the inner tube 28. The piston 30 and the inner tube 28 define a rebound working chamber 32 and compression working chamber 34. The damper 16 includes an outer tube 36 surrounding the inner tube 28. The inner tube 28 and the outer tube 36 define a fluid chamber 38 therebetween. The rebound working chamber 32, the compression working chamber 34, and the fluid chamber 38 contain a fluid, preferably a hydraulic oil suitable for use with dampers 16.

The intake assembly 22 is in the fluid chamber 38 for controlling fluid flow therein. The intake assembly 22 includes the unitary support ring 24a, 24b and pair of fulcrum spacers 26a, 26b. The intake assembly 22 includes one or more support posts 42 fixed to and extending along the axis A1 away from the unitary support ring 24a, 24b and pair of fulcrum spacers 26a, 26b. The intake assembly 22 includes at least one valve ring 44a, 44b supported by the support post 42. The valve ring 44a, 44b defines an orifice 46a, 46b. The intake assembly 22 includes one or more valve discs 48a, 48b, e.g., one or more bendable first valve discs 48a and one or more bendable second valve discs 48b, supported by the support post 42 between the valve ring 44a, 44b and the unitary support ring 24a, 24b and pair of fulcrum spacers 26a, 26b. The valve disc 48a, 48b covers the orifice 46a, 46b of the valve ring 44a, 44b and may control fluid flow therethrough.

The damper 16 includes an active rebound valve 50 in fluid communication with the rebound working chamber 32 through the fluid chamber 38 and a distal orifice 52 of the inner tube 28. The active rebound valve 50 has a variable flow resistance controllable by the ECU 20. The damper 16 also includes an active compression valve 54 that is in fluid communication with compression working chamber 34 through a proximate inner tube orifice 56. The active compression valve 54 has a variable flow resistance controllable by the ECU 20. The active rebound valve 50 and active compression valve 54 are positioned external to the outer tube 36 as shown and may be separated by a gap 58. The active rebound valve 50 and active compression valve 54 may be circumferentially spaced from each other about the outer tube 36 (not shown). The intake assembly 22 is provided within the fluid chamber 38 and may be positioned at the gap 58. The intake assembly 22 is in selective fluid communication with active rebound valve 50 and active compression valve 54 through an outer tube intake orifice 60 whereby the intake assembly 22 controls flow during a rebound and compression stroke.

The active rebound valve 50 is in fluid communication with the fluid chamber 38 through an active rebound valve orifice 62 in the outer tube 36, and with the rebound working chamber 32 through the distal orifice 52 of the inner tube 28. The distal orifice 52 fluidly communicates with the rebound working chamber 32. During a rebound stroke fluid flows from the rebound working chamber 32, out the distal inner tube orifice 56 through the fluid chamber 38, through the active rebound valve orifice 62 in the outer tube 36 into the active rebound valve 50 and through the intake assembly 22 into the compression working chamber 34 through the proximate inner tube orifice 56 into the compression working chamber 34. The active compression valve 54 is in fluid communication with the fluid chamber 38 through an outer tube active compression valve orifice 64 and the proximate inner tube orifice 56. During a compression stroke, fluid flows from the compression working chamber 34, out the proximate inner tube orifice 56, through the active compression valve orifice 64 in the outer tube 36, into the active compression valve 54, through the intake assembly 22, through the fluid chamber 38 and into the rebound working chamber 32 through the distal inner tube orifice 56.

The intake assembly 22 is supported in the fluid chamber 38 between the inner tube 28 and the outer tube 36 of the damper 16. For example, one or more components of the intake assembly 22 may be compressed between the inner tube 28 and the outer tube 36, such as to an outer surface 66 of the inner tube 28 and/or to an inner surface 68 of the inner tube 28. As other example, the one or more components of the intake assembly 22 may be fixed to the inner tube 28 and/or the outer tube 36, e.g., via weld, adhesive, fastener, etc.

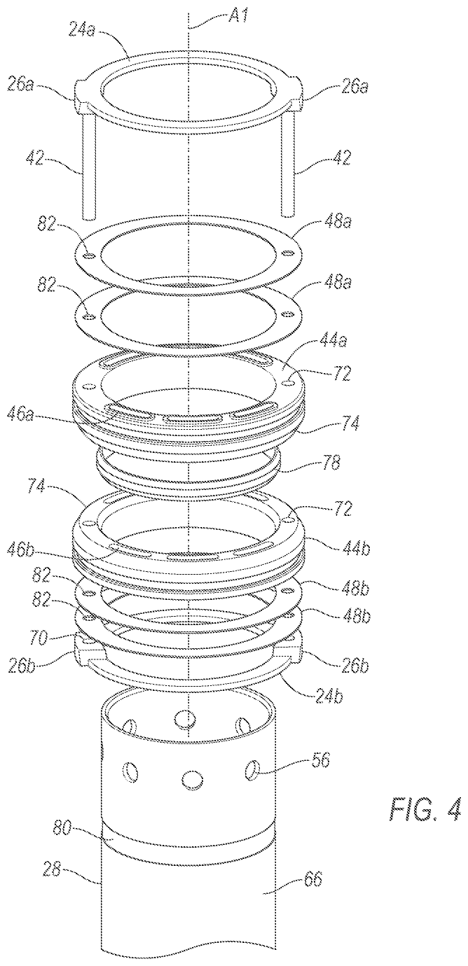

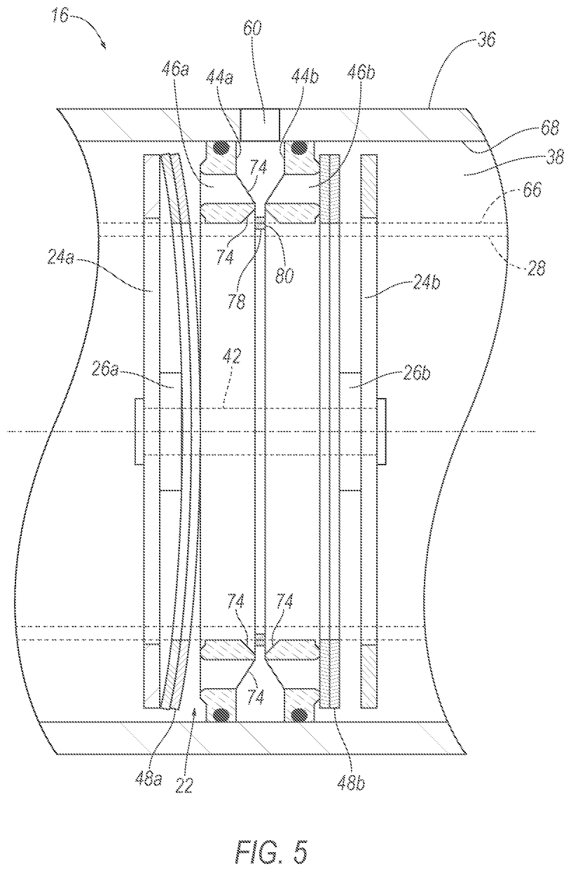

With reference to FIGS. 4 and 5 the intake assembly 22 is shown in greater detail. The intake assembly 22 may include a first support ring 24a and a second support ring 24b. The first support ring 24a may be at one end of the intake assembly 22 and the second support ring 24b may be at an opposite end of the intake assembly 22. Other components of the intake assembly 22, e.g., the valve rings 44a, 44b and the valve discs 48a, 48b, may be disposed between the first and second support rings 24a, 24b.

The intake assembly 22 includes the fulcrum spacers 26a, 26b to enable bending of the respective valve discs 48a, 48b and provide spacing between the respective valve discs 48a, 48b and support rings 24a, 24b. The supports rings 24a, 24b and the respective fulcrum spacers 26a, 26b are unitary. For example, a first support ring 24a and pair of first fulcrum spacers 26a may be unitary with each other, and a second support ring 24b and pair of second fulcrum spacers 26b may be unitary with each other. The fulcrum spacers 26a, 26b are thicker than the support rings 24a, 24b, e.g., along the axis A1. The increased thickness of the fulcrum spacers 26a, 26b spacing between the respective valve discs 48a, 48b and support rings 24a, 24b and enables bending of the valve discs 48a, 48b toward the support rings 24a, 24b. The fulcrum spacers 26a, 26b may include two (and only two) fulcrum spacers 26a, 26b attached to each support ring 24a, 24b. The two fulcrum spacers 26a, 26b attached to the respective support ring 24a, 24b may be spaced from each other 180-degrees about the support ring 24a, 24b. In other words, the fulcrum spacers 26a, 26b may be opposite each other on the respective support ring 24a, 24b, e.g., having a diameter of the support ring 24a, 24b intersect the fulcrum spacers 26a, 26b. The intake assembly 22 may include more or less fulcrum spacers 26a, 26b connected to the support rings 24a, 24b than shown. When assembled, the fulcrum spacers 26a, 26b provide a pre-load to permit a suitable hydraulic seal such that fluid does not flow through the first valve ring 44a, e.g., during a compression stroke and similarly does not flow through the second valve ring 44b, e.g., during a rebound stroke.

The intake assembly 22 includes the support posts 42 to fix the support rings 24a, 24b relative to each other and to support other components of the intake assembly 22, e.g., limiting movement of the valve rings 44a, 44b and valve discs 48a, 48b transverse to the axis A1. The intake assembly 22 may include two and only two support posts 42, e.g., spaced from each other 180-degrees about the support rings 24a, 24b. The support posts 42 may extend away from one of the support rings 24a, 24b to the other of the support rings 24a, 24b. For example, each support post 42 may extend away from one of the first fulcrum spacers 26a of the first support ring 24a to one of the second fulcrum spacers 26b of the second support ring 24b. The support posts 42 extend along, e.g., are elongated parallel to, the axis A1.

The support posts 42 may be fixed to the support rings 24a, 24b and the fulcrum spacers 26a, 26b. The support post 42 may be press fit into holes 70 of the support rings 24a, 24b and fulcrum spacers 26a, 26b, the support posts 42 may be welded to the support rings 24a, 24b and fulcrum spacers 26a, 26b, the support posts 42 may be fixed to the support rings 24a, 24b and fulcrum spacers via fasteners or other suitable structure. For example, the support posts 42 may include threaded shafts and nuts may be engaged on the threaded shafts to urge one support ring toward the other support ring. As another example, the support posts 42 may be hollow and deformable to secure the support rings 24a, 24b to each other. In other words, the support posts 42 may provide rivets securing the support rings 24a, 24b to each other.

As described, the intake assembly 22 includes the first valve ring 44a and the second valve ring 44b. The first valve ring 44a and second valve ring 44b may have identical construction. The first valve ring 44a and the second valve ring 44b may face each other in a mirrored configuration. The first valve ring 44a may be spaced from the second valve ring 44b, e.g., along the axis A1. The first valve ring 44a and second valve ring 44b may each define respective orifices 46a, 46b. The orifices 46a, 46b may be arcuate in shape. The orifices 46a on the first valve ring 44a may be termed rebound orifices 46a, while the orifices 46b on the second valve ring 44b may be termed compression orifices 46b. The intake orifice 60 defined by the outer tube 36 may be between the first valve ring 44a and the second valve ring 44b along the axis A1, e.g., such that fluid may flow from the intake orifice 60 through the space between the second valve ring 44b and first valve ring 44a to the orifices 46a, 46b. The first valve ring 44a and second valve ring 44b may be supported by the support posts 42, e.g., between the unitary support rings 24a, 24b and fulcrum spacers 26a, 26b along the axis A1. The first valve ring 44a and second valve ring 44b may each include one or more fastening holes 72. The support posts 42 may be disposed within the fastening holes 72. The first valve ring 44a 54 and second valve ring 44b include respective tapered sections 74a, 74b. The tapered sections 74a may be radially outward and provide fluid access to the intake assembly 22 through the outer tube intake orifice 60. The tapered sections 74b may be radially inward, e.g., to apply force on a clamping ring 78 as further discussed below.

The first valve ring 44a and second valve ring 44b have an outer diameter that substantially corresponds to an inner diameter of the outer tube 36 and an inner diameter that substantially corresponds to the outer diameter of inner tube 28. As shown, a pair of O-Rings 76 may be included to seal the first valve ring 44a and the second valve ring 44b to the outer tube 36.

The intake assembly 22 may include the clamping ring 78. The clamping ring 78 may be disposed between the first valve ring 44a and the second valve ring 44b. A radially outmost surface of the clamping ring 78 may be radially inward of the rebound orifices 46a and the compression orifices 46b. The clamping ring 78 may secure the intake assembly 22 to the outer surface 66 of the inner tube 28. For example, normal forces from the tapered sections 74b of the first valve ring 44a and the second valve ring 44b may compress the clamping ring 78 against the inner tube 28. As another example, the clamping ring 78 may be received in a groove 80 that extends circumferentially about the outer surface 66 of the inner tube 28.

The intake assembly 22 includes the valve discs 48a, 48b to control fluid flow through the orifices 46a, 46b of the valve rings 44a, 44b. The valve discs 48a, 48b cover the orifices 46a, 46b, e.g., inhibiting fluid flow in one direction and selectively permitting flow fluid in an opposite direction. At least one valve disc 48a, 48b may abut each of the valve rings 44a, 44b, e.g., about perimeters of the orifices 46a, 46b. To allow clearance, e.g., for the valve discs 48a, 48b to move away from the orifices 46a, 46b, an outer diameter of the valve discs 48a, 48b are less than the inner diameter of the outer tube 36. Likewise, an inner diameter of the valve discs 48a, 48b is greater than the outer diameter of the inner tube 28.

The valve discs 48a, 48b may be supported by the support posts 42. For example, the valve disc may include fastener holes 82 and the support posts 42 may be disposed within the fastener holes 82. The valve discs 48a, 48b may be supported by the support posts 42 between the respective support rings 24a, 24b and valve rings 44a, 44b along the axis A1. For example, first valve discs 48a may be supported between the first support ring 24a and the first valve ring 44a, and second valve discs 48b may be supported between the second support ring 24b and the second valve ring 44b. In the example shown in the Figures, the intake assembly 22 includes two valve discs 48a between the first support ring 24a and the first valve ring 44a and two valve discs 48b between the second support ring 24b and the second valve ring 44b. The intake assembly 22 may include greater or fewer valve discs 48a, 48b.

The damper 16 may include an accumulator 84. The accumulator 84 is in fluid communication with the active rebound valve 50 and active compression valve 54 through an accumulator orifice 86. The accumulator 84 includes a low-pressure chamber 88 84 that is separated from the compression working chamber 34 by an end wall 90. The accumulator 84 80 further includes a flexible membrane 92 and a gas chamber 94. The accumulator 84 can receive or discharge fluid as is known in the art.

With reference to FIG. 2, a rebound stroke will be described in greater detail. During the rebound stroke the piston 30 moves in the direction of arrow A. As shown fluid is forced out the distal inner tube orifice 56 into the fluid chamber 38. Fluid flows through fluid chamber 38 and travels into the active rebound valve 50. As shown the fluid is held against the intake assembly 22 by a hydraulic seal of the second valve disc 48b against the second valve ring 44b. The active rebound valve 50 is controlled by the ECU 20 to provide the desired damping effect. The fluid flows from the active rebound valve 50 and through the outer tube intake orifice 60. As the compression working chamber 34 enlarges the pressure therein is less than the pressure at the inlet and the low-pressure chamber 88. This pressure difference acts on the first valve disc 48a to move the bendable disc 48a away from the rebound orifices 46a. The rebound fulcrum spacer 26a may be sized and selected to require a greater or lesser fluid pressure to bend the rebound disc 48a away from the rebound orifice 46a. As shown fluid, as necessary may travel from the low-pressure chamber 88 of the accumulator 84 through the outer tube intake orifice 60. Fluid will then flow through the proximate inner tube orifice 56 and into the compression working chamber 34 until the rebound stroke is complete.

With reference to FIG. 3, a compression stroke will be described in greater detail. During the compression stroke the piston 30 move in the direction of arrow B. As shown fluid is forced from the proximate inner tube orifice 56 and into the active compression valve 54, through fluid chamber 38 and outer tube active compression valve orifice 64. The bendable rebound disc 48a is held closed against the rebound orifice 46a by hydrostatic pressure. The fluid flows through the active compression valve 54 as controlled by the ECU 20. As the rebound working chamber 32 enlarges, the pressure therein is less than the pressure at the inlet and the pressure in the compression working chamber 34 is more than the pressure in the low-pressure chamber 88. Here, fluid enters the intake assembly 22 from the outer tube intake orifice 60 and forces the bendable compression disc 48b away from the compression orifices 46b. As shown fluid may flow into the low-pressure chamber of the accumulator 84 as needed. Fluid flows into the fluid chamber 38, through the distal inner tube orifice 56 and into the rebound working chamber 32 until the compression stroke is complete.

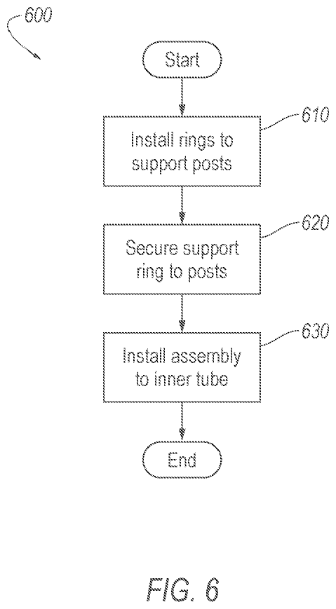

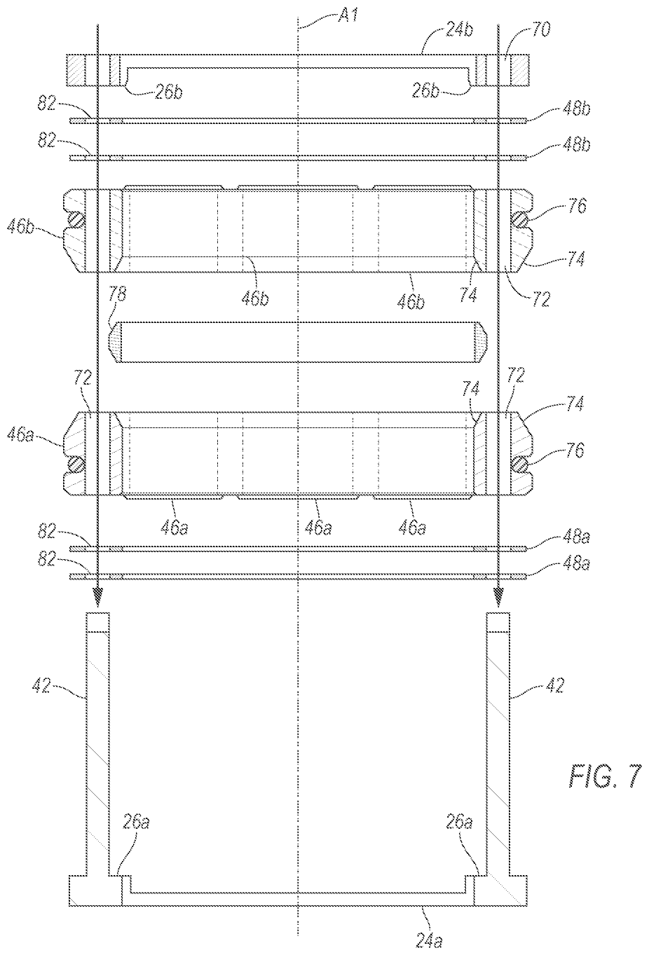

Turning to FIG. 6, a flow chart illustrating a method 600 of assembling the damper 16 is shown. The method 600 begins a step 610 where one or more first valve discs 48a, the first valve ring 44a, the clamping ring 78, the second valve ring 44b, and one or more second valve discs 48b are installed onto the pair of support posts 42 attached to the first support ring 24a. For example, and with defence to FIG. 7, the support posts 42 may be inserted into the fastener holes 82 of the first valve discs 48a, the fastener holes 72 of the first valve ring 44aa and the second valve ring 44b, and the fastener holes 82 of the second valve discs 48a, 48b. The first valve discs 48a may be between and in abutment with the first valve ring 44a. The second valve discs 48b may abut the second valve ring 44b.

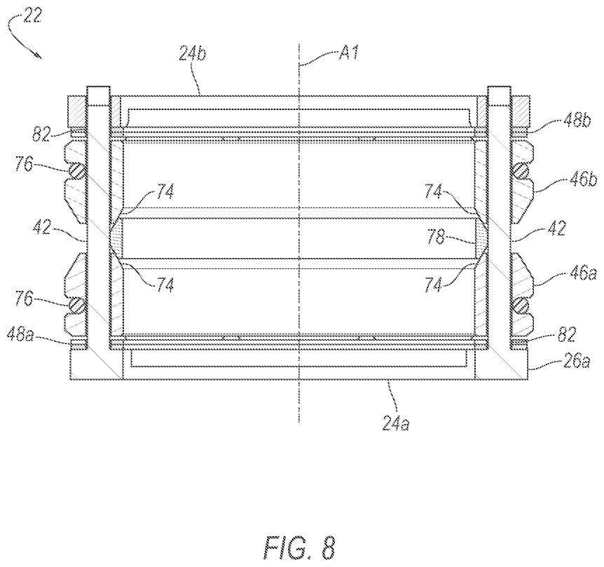

Next, at a step 620, the unitary second support ring 24b and second pair of fulcrum spacers 26b are secured to the support posts 42 opposite the first support ring 24a to provide the intake assembly 22. For example, the unitary second support ring 24b and second pair of fulcrum spacers 26b may be installed onto the support posts 42, as shown in FIG. 8. In other words, the support posts 42 may be inserted into the holes 70 of the unitary second support ring 24b and second pair of fulcrum spacers 26b. After insertion, the unitary second support ring 24b and second pair of fulcrum spacers 26b may be fixed to the support posts 42, e.g., via weld, adhesive, friction fit, nuts or other fasteners engaged with the support posts 42, partially or fully riveting the support posts 42, etc.

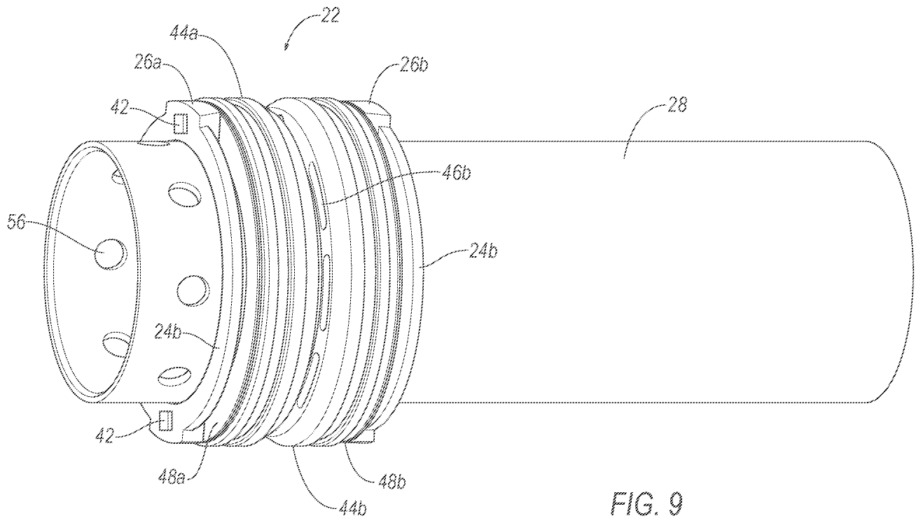

Next, at a step 630 the intake assembly 22 is installed onto the inner tube 28 of the damper 16. The intake assembly 22 may be installed by inserting the inner tube 28 into a central opening (not numbered) of the intake assembly 22, as shown in FIG. 9. The intake assembly 22 may be slid along the inner tube 28 to a desired position. For example, the intake assembly 22 may be slid along the inner tube 28 until the clamping ring 78 engages the groove 80 of the inner tube 28. The first valve discs 48a, the first valve ring 44a, the clamping ring 78, the second valve ring 44b, and the second valve discs 48b may be compressed between the unitary first support ring 24a and first pair of fulcrum spacers 26a and the unitary second support ring 24b and second pair of fulcrum spacers 26b. The compression may be provided by further riveting the support posts 42, tightening nuts engaged with the support posts 42, etc. The compression may urge the clamping ring 78 against the outer surface 66 of the inner tube 28. After the intake assembly 22 is installed onto the inner tube 28, assembly the damper 16 may be completed, e.g., with conventional methods.

The adjectives first, second, etc., are used throughout this document as identifiers and, unless explicitly stated otherwise, are not intended to signify importance, order, or quantity.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A damper, comprising:
an inner tube elongated along an axis;
a piston slidably disposed in the inner tube;
an outer tube surrounding the inner tube, the inner tube and outer tube defining a fluid chamber therebetween; and
an intake assembly in the fluid chamber, the intake assembly including:
a unitary support ring and pair of fulcrum spacers,
a support post fixed to and extending along the axis away from the unitary support ring and pair of fulcrum spacers,
a valve ring supported by the support post, the valve ring defining an orifice, and
a valve disc supported by the support post between the valve ring and the unitary support ring and pair of fulcrum spacers, the valve disc covering the orifice of the valve ring.

2. The damper of claim 1, further comprising a second support ring, a second valve ring defining a second orifice, and a second valve disc covering the second orifice of the second valve ring, both the second valve ring and the second valve disc supported by the support post between the second support ring and the valve ring.

3. The damper of claim 2, wherein the outer tube defines an intake orifice between the valve ring and the second valve ring along the axis.

4. The damper of claim 2, further comprising a second pair of second fulcrum spacers unitary with the second support ring.

5. The damper of claim 4, wherein the support post extends from one fulcrum spacer of the pair of fulcrum spacers to one second fulcrum spacer of the second pair of second fulcrum spacers.

6. The damper of claim 5, further comprising a second support post extending from another fulcrum spacer of the pair of fulcrum spacers to another second fulcrum spacer of the second pair of second fulcrum spacers.

7. The damper of claim 1, wherein the pair of fulcrum spacers are spaced from each other 180-degrees about the support ring.

8. The damper of claim 1, wherein the pair of fulcrum spacers are thicker than the support ring along the axis.

9. An intake assembly supportable between an inner tube and an outer tube of a damper, the intake assembly comprising:
a unitary support ring and pair of fulcrum spacers;
a second support ring;
a support post fixed to and extending away from the unitary support ring and pair of fulcrum spacers to the second support ring;
a valve ring supported by the support post, the valve ring defining an orifice; and
a valve disc supported by the support post between the valve ring and the unitary support ring and pair of fulcrum spacers, the valve disc covering the orifice of the valve ring.

10. The intake assembly of claim 9, further comprising a second valve ring defining a second orifice and a second valve disc covering the second orifice of the second valve ring, both the second valve ring and the second valve disc supported by the support post between the second support ring and the valve ring.

11. The intake assembly of claim 10, wherein the valve ring is spaced from the second valve ring.

12. The intake assembly of claim 11, further comprising a clamping ring between the valve ring and the second valve ring.

13. The intake assembly of claim 10, further comprising a second pair of second fulcrum spacers unitary with the second support ring.

14. The intake assembly of claim 13, wherein the support post extends from one fulcrum spacer of the pair of fulcrum spacers to one second fulcrum spacer of the second pair of second fulcrum spacers.

15. The intake assembly of claim 14, further comprising a second support post extending from another fulcrum spacer of the pair of fulcrum spacers to another second fulcrum spacer of the second pair of second fulcrum spacers.

16. The intake assembly of claim 9, wherein the pair of fulcrum spacers are spaced from each other 180-degrees about the support ring.

17. The intake assembly of claim 9, wherein the pair of fulcrum spacers are thicker than the support ring.

18. A method, comprising:
installing a first valve disc, a first valve ring, a clamping ring, a second ring, and a second valve disc onto a pair of posts attached to a unitary support ring and pair of fulcrum spacers; and
then securing a unitary second support ring and second pair of fulcrum spacers to the posts opposite the unitary support ring and pair of fulcrum spacers to provide a intake assembly.

19. The method of claim 18, further comprising installing the intake assembly onto an inner tube of a damper.

20. The method of claim 19, further comprising securing the intake assembly to the inner tube by compressing the first valve disc, the first valve ring, the clamping ring, the second ring, and the second valve disc between the unitary support ring and pair of fulcrum spacers and the unitary second support ring and second pair of fulcrum spacers.
